(19) United States
(12) Patent Application Publication
(10) Pub. No.: US 2022/0106948 A1
(43) Pub. Date: Apr. 7, 2022

(54) PUMP COMPRISING AN ELECTRIC MOTOR WITH PLUG CONNECTION IN THE FORM OF AN INTERMEDIATE RING

(71) Applicant: NIDEC GPM GmbH, Auengrund OT Merbelsrod (DE)

(72) Inventors: Frank SCHWAMBERGER, Schleusingen (DE); Jens HOFFMANN, Schwarzbach (DE); Conrad NICKEL, Troistedt (DE); Jakob SCHNITZER, Hilburghausen (DE)

(21) Appl. No.: 17/424,186

(22) PCT Filed: Jan. 17, 2020
(86) PCT No.: PCT/EP2020/051081

§ 371 Date: Jul. 20, 2021

(30) Foreign Application Priority Data
Jan. 30, 2019 (DE) 10 2019 102 318.1

(51) Int. Cl. F04B 17/03; H02K 3/28; H02K 5/22

(52) U.S. Cl. CPC F04B 17/03; H02K 11/33; H02K 5/225; H02K 3/28

(57) ABSTRACT

A pump includes an electric motor with a rotor mounted rotatably about an axis of rotation and surrounding a stator circumferentially. The stator includes a stator core and coils wound on the stator core, the coils being made from a winding wire with winding wire end sections electrically contacted at an end surface with a printed circuit board. The printed circuit board is surrounded by a plug assembly circumferentially with respect to the axis of rotation. The plug assembly includes contacts which are electrically contacted at a first end with the printed circuit board and are directed radially outwardly at a second end in order to define a plug to contact the printed circuit board with an electrical controller.

### CROSS REFERENCE TO RELATED APPLICATIONS

This is a U.S. national stage of PCT Application No. PCT/EP2020/051081, filed on Jan. 17, 2020, and with priority under 35 U.S.C. § 119(a) and 35 U.S.C. § 365(b) being claimed from German Application No. 102019102318.1, filed Jan. 30, 2019; the entire disclosures of which are hereby incorporated herein by reference.

### FIELD OF THE INVENTION

The present invention relates to a pump and to an electric drive.

### BACKGROUND

Water pumps often feature DC motors. The DC motors comprise a rotor connected to a motor shaft and rotatably mounted in a housing. The rotor is provided with permanent magnets. A stator is arranged in the rotor, which carries a number of windings on an iron core. When suitably controlled, the windings generate a magnetic field that drives the rotor to rotate. The windings are usually wound in three phases and are accordingly provided with three electrical connections through which the windings can be connected to a controller (ECU). At low power levels, busbars in the form of conductor foils can be used. For higher power levels, the winding connection wires are contacted via busbars made of a copper sheet.

For the purpose of the geometrical description of the electric motor, the axis of rotation of the motor is assumed to be the center axis and axis of symmetry. The rotor is arranged concentrically to the axis of rotation around the stator.

For the electric motors discussed here, in addition to the performance data and weight, the dimensions are also essential. Therefore, it is a constant requirement for the design of electric motors, for example, not to exceed a certain axial length in the direction of the central axis. In this context, the performance data required of the electric motor essentially determine the axial length of the stator pack as well as of the rotor with the electromagnets arranged on it. The busbar unit, which is required for contacting the winding connection wires of the stator, contributes to the axial length.

From the patent specification U.S. Pat. No. 7,588,444 B2, a pump with an electric motor is known, which has a busbar unit with a plurality of busbars, wherein the busbar holder is made of an injection-molded, non-conductive thermoplastic resin material.

### SUMMARY

Example embodiments of the present disclosure improve pumps each including an electric motor in such a way that each pump takes up little installation space and includes as few components as possible.

Accordingly, a pump according to an example embodiment of the present invention includes an electric motor including a rotor which is rotatably mounted about an axis of rotation and which circumferentially surrounds a stator. The stator includes a stator core and coils wound on the stator core, the coils are made from a winding wire including winding wire end sections electrically contacted with a printed circuit board at an end surface. The printed circuit board is surrounded by a plug assembly circumferentially to the axis of rotation, the plug assembly includes contacts which are injection molded into the plug assembly and which are electrically contacted with a first end with the printed circuit board and are directed at least partially radially outwardly with a second end to define a plug to contact the printed circuit board with an electrical controller. The plug assembly enables simple electrical connection of the circuit board to the electrical controller, which is accompanied by a significant reduction in cost. In addition, sealing is simplified and contact points can be reduced or minimized, since no intermediate connectors are required, which can significantly reduce the probability of failure. The electrical contact between the winding wire end sections and the printed circuit board is preferably made directly, i.e., preferably no intermediate connectors or other connecting elements are provided. The connection is made in particular via insulation displacement connectors, preferably IDC.

Preferably, the rotor and the stator are surrounded by a motor housing in which a pump housing is at least partially accommodated, the plug assembly extending the direction of the axis of rotation between the motor housing and the pump housing. A major advantage of the plug assembly is the resulting small pump installation space.

The pump housing preferably includes a housing structure which includes a base plate and a dome projecting centrally from the base plate, the base plate and the dome including a central opening extending therethrough, and the stator being seated firmly on an outside of the dome, and a motor shaft of the electric motor, which is connected to the rotor in a rotationally fixed manner, extending through the central opening of the housing structure.

In an example embodiment, the plug assembly includes a cylindrical base body with a shell and a circular base surface, which is preferably arranged concentrically to the axis of rotation, with a connection area projecting radially outwards from the outside of the shell, into which the contacts are inserted and which defines the plug. The contacts of the plug assembly can be press-fit contacts or solder contacts.

The connection and seal between the motor housing, plug assembly and water pump housing thus preferably has a simple circular contour.

The plug assembly can include webs projecting inward on an inside of the shell and extending parallel or substantially parallel to the axis of rotation to center the motor housing on the plug assembly. The webs can also support the printed circuit board.

Preferably, the housing portion of the pump housing includes a centering ring on which the printed circuit board is seated.

Preferably, a first side of the plug assembly is in annular contact with the motor housing and a second side is in annular contact with the pump housing portion. Preferably, the plug assembly is inserted between the housings in such a way that only the plug protrudes on the outside and the cylindrical geometry of the pump is otherwise maintained.

It is also possible for the motor housing and the plug assembly to be manufactured in a single piece in an injection molding process. The motor housing with the plug assembly is then in direct contact with the pump housing. The motor housing can be pot-shaped or cylindrical with a through-opening.

The pump is preferably a dry-running pump and is in particular a water pump, preferably a coolant pump for motor vehicles.

There is further provided, in a very general manner, an electric drive including the plug assembly previously described.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal section through a pump with an electric motor and plug assembly according to an example embodiment of the present disclosure.

FIG. 2 is a spatial view of the plug assembly of FIG. 1.

FIG. 3 is a longitudinal section through another pump with an electric motor and integrated plug assembly according to an example embodiment of the present disclosure.

FIG. 4 is a longitudinal section through another pump with an electric motor and integrated plug assembly according to an example embodiment of the present disclosure.

FIG. 5 is a schematic representation of a first assembly step of the pump shown in FIG. 1.

FIG. 6 is a schematic representation of a second assembly step of the pump shown in FIG. 1.

FIG. 7 is a schematic representation of a third assembly step of the pump shown in FIG. 1.

FIG. 8 is a schematic representation of a fourth assembly step of the pump shown in FIG. 1.

### DETAILED DESCRIPTION

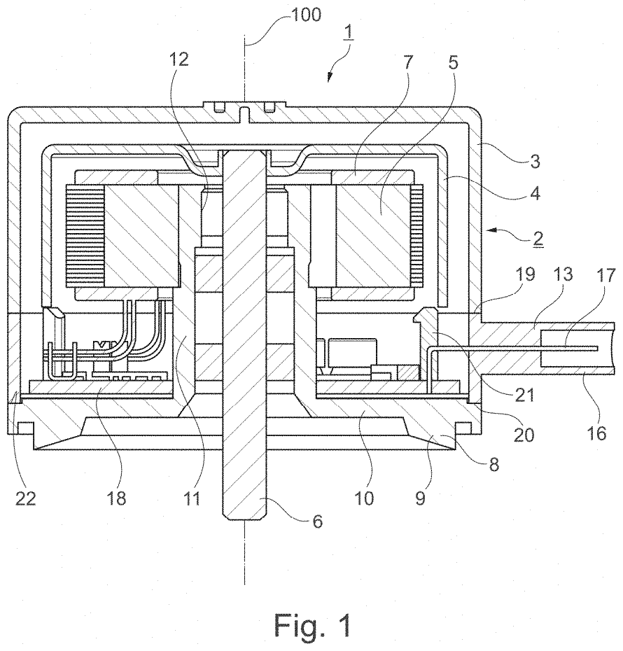

FIGS. 1, 3 and 4 show a water pump 1 with an electric motor 2 comprising a motor housing 3. A rotor 4 and a stator 5 are arranged in the motor housing 3. The rotor 4 surrounds the stator concentrically to an axis of rotation 100. The rotor 4 is connected to a motor shaft 6 for transmitting a torque. The water pump 1 is designed as a dry rotor. The electric motor 2 is a brushless DC motor. The stator 5 has a stator core which extends coaxially with respect to the axis of rotation 100 and has a plurality of stator core segments, not shown, around each of which coils 7 are wound. The coils 7 are shown only schematically. The stator 5 is fixedly mounted within the motor housing 3 and is adapted to generate a time-varying magnetic field by means of the coils 7. The magnetized rotor 4 surrounds the stator 5 circumferentially. It is arranged to be rotated by interaction with the time-varying magnetic field generated by the coils 7.

The motor housing 3 has a connection for a pump housing 8. The pump housing 8 comprises a housing portion 9, which has a base plate 10 and a dome 11 projecting centrally from the base plate 10. The base plate 10 and the dome 11 have a central opening 12 passing through them. The stator 5 sits firmly on the outside of the dome 11. The motor shaft 6 passes through the central opening of the housing portion 12 and is rotatably mounted inside the dome 11. Seals, in particular mechanical seals inside the dome 11 guarantee that the fluid to be pumped does not penetrate the electric motor 2. The motor housing 3 sits indirectly or directly on the pump housing 8. The dome 11 forms a heat conduction path.

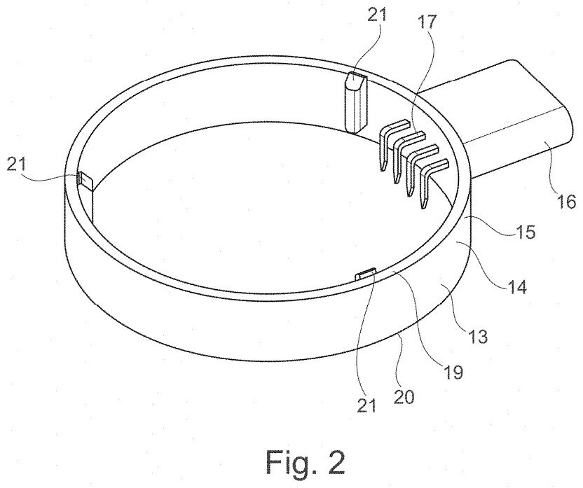

FIG. 1 shows a preferred example embodiment of the pump 1 with a plug assembly 13 shown in FIG. 2. The plug assembly 13 has a substantially cylindrical base body 14 with a jacket 15 and a circular base. A connection region 16 projects radially outwardly from an outer surface of the shell 15, in which contacts 17 are provided for connecting a printed circuit board 18 to an electrical controller.

The plug assembly 13 is arranged in the direction of the axis of rotation 100 between motor housing 3 and pump housing 8,9. Thus, a first side 19 of the plug assembly is in annular contact with the motor housing 3 and a second side 20 is in annular contact with the pump housing portion 9. The plug assembly 13 surrounds the circuit board 18 on the circumferential side. The contacts 17 penetrate the connection area 16 and protrude from the inner side of the shell 15. The connection area 16 forms a plug.

The contacts 17 are preferably connected to the printed circuit board 18 by forming a press-fit connection. However, conventional solder pin connections or flat solder contacts can also be provided for making the connection.

On the inside of the shell 15, the plug assembly 13 has webs 21 which project inwards and run parallel to the axis of rotation 100 and serve as centering elements. The centering elements 21 project axially slightly and map the inner diameter of the plug assembly. They engage in a defined manner in the motor housing 3 to ensure centering about the axis of rotation. In addition, the centering elements 21 serve to support the printed circuit board 18. The centering elements rest on the printed circuit board 18 and form an axial support. A centering ring 22 is formed by the base plate 10 of the housing portion 9 on the outside and surrounds the dome 11 on the circumference. It serves to center the position between the pump housing and the plug assembly.

The plug assembly 13 is injection molded and preferably formed of plastic.

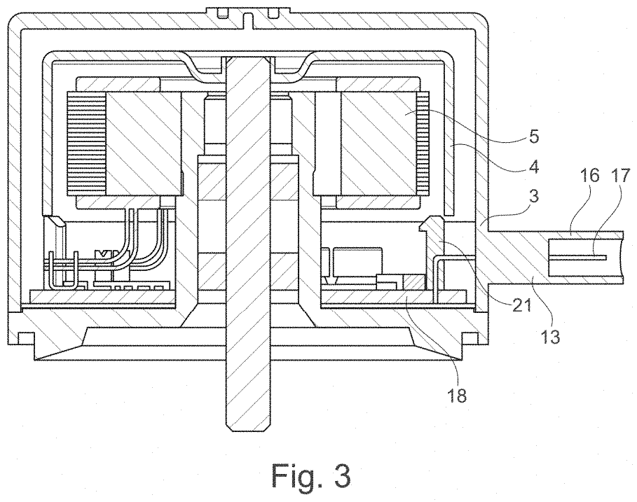

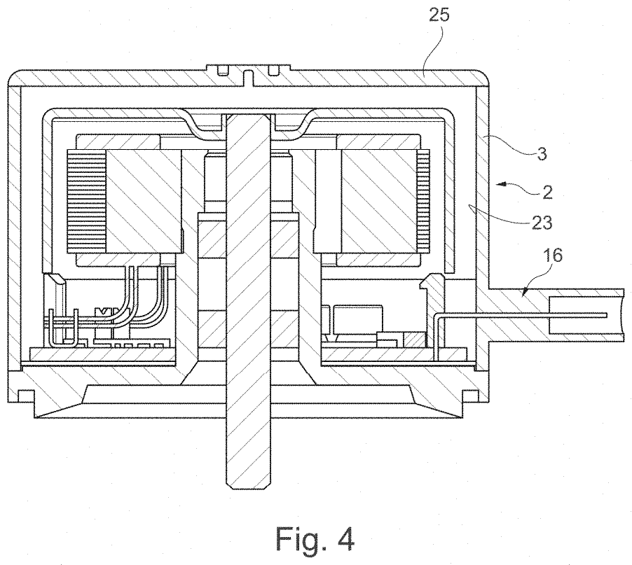

FIGS. 3 and 4 show further example embodiments of pump 1. The differences to the previously described example embodiment will be discussed below.

FIG. 3 shows a one-piece motor housing 3 with integrated plug assembly 13. The contacts 17 are surrounded with plastic by injection molding during the manufacture of the motor housing 3 and are thus integrated. The motor housing 3 is therefore pot-shaped and surrounds not only the rotor 4 and the stator 5 but also the circuit board 18 on the periphery. On the inside at the end near the pump housing, the motor housing 3 has webs 21 running parallel to the axis of rotation 100, which form contact surfaces for the printed circuit board 18 at their end surfaces. On the outside, the motor housing 3 has a projection extending in the radial direction to form a connection area 16 or connector. Embedded in the connection area 16 are the contacts 17, which pass through the casing 15 of the motor housing 3 and project into the interior for electrical connection to the printed circuit board 18.

The motor housing 3 is injection molded and preferably formed from plastic. The plug assembly 13 and the motor housing 3 are thus manufactured as a single common injection-molded part.

FIG. 4 shows another possible example embodiment, whereby again only the differences are discussed. The motor housing is essentially cylindrical with an annular base and has an opening 23 passing through it. The motor housing 3 is integrally formed with the plug assembly 13 as described with respect to FIG. 3. A cover 25 covers the motor housing 3 at the end remote from the pump housing. The electric motor 2 can be easily inserted through the opening 23 of the motor housing 3.

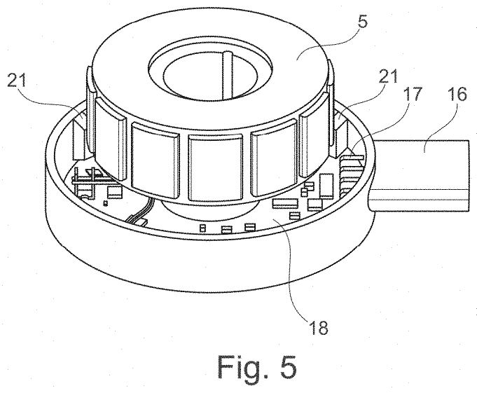

FIGS. 5 to 8 show the individual assembly steps of the pump 1 shown in FIG. 1.

As can be seen from FIG. 5, in a first step the plug assembly 13 is placed onto the printed circuit board 18 in the direction of the axis of rotation. The stator of the electric motor 5 is already connected to the printed circuit board 18. Since the plug assembly 13 surrounds the circuit board 18 circumferentially, there is sufficient clearance for soldering the plug contacts 17 to the circuit board 18. In a press-fit assembly, on the other hand, good supporting options are available. The axial mounting position is defined by the webs 21 of the plug assembly and by force-displacement monitoring during press-fitting.

It may be provided that the printed circuit board is circumferentially enclosed by the cylindrical base body 14 of the plug assembly and is potted with a potting compound to protect the components.

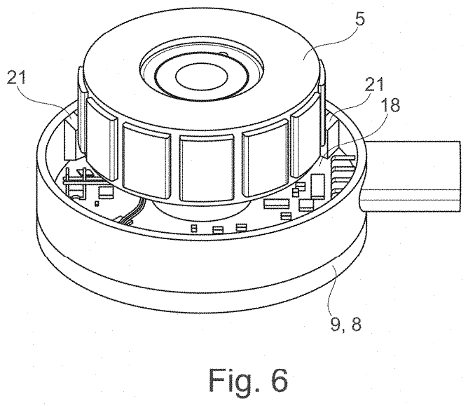

FIG. 6 shows the result of the next assembly step. The stator 5 is pressed onto the dome 11 of the housing portion 9 of the pump housing 8 and centered by means of the dome. The dome 11 is slightly deformed during pressing. The printed circuit board 18 is held between the housing portion 9 and the webs 21 of the plug assembly.

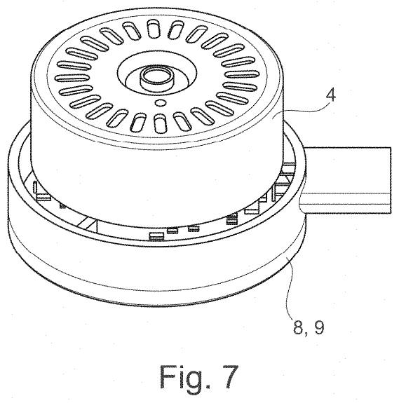

In the subsequent assembly step shown in FIG. 7, the rotor assembly comprising the rotor 4 and the motor shaft not shown is assembled. The motor shaft is inserted into the bearing located in the central opening 12 of the pump housing 8.

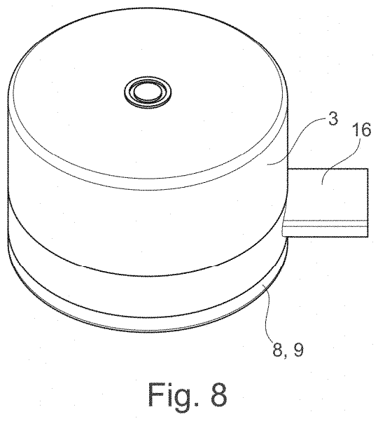

FIG. 8 shows the result of the last assembly step. The motor housing 3 is placed on the preassembled assembly in the axial direction. Radial centering is achieved via the webs on the plug assembly. Preferably, the motor housing 3 and the plug assembly 13, as well as the plug assembly 13 and the pump housing 8,9 are welded, preferably by means of a laser, or glued.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. A pump comprising:
an electric motor with a rotor which is mounted rotatably about an axis of rotation and which surrounds a stator circumferentially; wherein
the stator includes a stator core and coils wound on the stator core, the coils are made from a winding wire with winding wire end sections electrically contacted on an end surface with a printed circuit board;
the printed circuit board is surrounded by a plug assembly circumferentially with respect to the axis of rotation;
the plug assembly includes contacts which are injection-molded into the plug assembly and which are electrically contacted at a first end with the printed circuit board, and which are directed at least partially radially outwardly at a second end to define a plug to contact the printed circuit board with an electrical controller.

13. The pump according to claim 12, wherein
the pump housing includes a housing structure which includes a base plate and a dome projecting centrally from the base plate;
the base plate and the dome include a central opening extending therethrough, and the stator is seated fixedly on the outside of the dome; and
a motor shaft of the electric motor, the motor shaft being rotatably connected to the rotor and extending through the central opening of the housing structure.

14. The pump according to claim 12, wherein the plug assembly includes a cylindrical base body with a casing and a circular base surface and a connection region projecting radially outwards from an outside of the casing, the contacts are introduced into the connection region which defines the plug.

15. The pump according to claim 14, wherein the plug assembly includes webs projecting inwards on an inside of the casing and extending parallel or substantially parallel to the axis of rotation to center the motor housing.

16. The pump according to claim 12, wherein the housing structure of the pump housing includes a centering ring on which the plug assembly is seated and axially aligned.

17. The pump according to claim 12, wherein the rotor and the stator are surrounded by a motor housing in which a pump housing is at least partially accommodated, the plug assembly extending in a direction of the axis of rotation between the motor housing and the pump housing.

18. The pump according to claim 17, wherein the plug assembly includes a first side having an annular shape against the motor housing and a second side having an annular shape against the pump housing portion.

19. The pump according to claim 12, wherein the motor housing and the plug assembly are injection-molded defining a single unitary structure and the pump housing is in contact with the plug assembly.

20. The pump according to claim 12, wherein the pump is a dry rotor.

21. The pump according to claim 12, wherein the contacts are press-fit contacts or soldered contacts.

22. An electric drive, comprising:
an electric motor with a rotor which is rotatably mounted about an axis of rotation and which circumferentially surrounds a stator; wherein
the stator includes a stator core and coils wound on the stator core, and the coils are made from a winding wire with winding-wire end sections electrically contacted with a printed circuit board at an end surface;
the printed circuit board is surrounded by a plug assembly circumferentially with respect to the axis of rotation, the plug assembly including contacts which are injection-molded into the plug assembly and which are electrically contacted with the printed circuit board at a first end and are directed at least partially radially outwardly at a second end to define a plug to contact the printed circuit board with an electrical controller.
